(19) United States
(12) Patent Application Publication
(10) Pub. No.: US 2004/0071960 A1
(43) Pub. Date: Apr. 15, 2004

(54) Glass body with improved strength

(76) Inventors: Andreas Weber, Mainz (DE); Roland Burkle, Kirchent Ellinsfuit (DE); Silke Deutschbein, Mainz (DE); Andreas Habeck, Budenheim (DE); Reiner Mauch, Ingelheim (DE)

Correspondence Address: John F Hoffman, Baker & Daniels, 111 East Wayne Street, Suite 800, Fort Wayne, IN, 46802, US

(21) Appl. No.: 10/018,977

(22) PCT Filed: Apr. 5, 2001
(86) PCT No.: PCT/EP01/03892

(30) Foreign Application Priority Data
Apr. 18, 2000 (DE) 100 19 355.2

(51) Int. Cl. B32B 1/00; B32B 17/06; B32B 9/00; B32B 9/04; B32B 13/04

(52) U.S. Cl. 428/336; 428/428; 428/447

(57) ABSTRACT

The present invention relates to the domain of toughened glass bodies, comprising a base body made of glass and at least one layer applied thereto.

According to the invention at least one layer is under a defined compressive stress or under a defined tensile stress.

The present invention relates to glass bodies of any shape, for example in the form of flat sheets or in three-dimensional form of greater thickness.

In numerous applications such glass bodies require particularly high strength, in particular a surface strength. Chemical or thermal treatments are considered for this purpose.

With thermal hardening of glass compressive stresses are frozen on the surface,while tensile stresses are frozen in the core due to the lower cooling rate. The width of the compressive stress zone is approximately ⅕ of the thickness of the glass. Thermal hardening, however, is limited to sheets having a thickness>3 mm.

By comparison to thermal hardening chemical hardening is based on the fact that compressive stresses in the glass surface transpire by modification to the composition of the surface area relative to the interior of the glass. In most cases this modification is accomplished by an alkali ion exchange at temperatures below the transformation temperature Tg. In the process the glass is treated in potassium nitrate smelting at approximately 50-150° C. below Tg for several hours. A compressive stress zone, whose depth is ca. 60-150 μm results from the exchange of Na to K. This method also is restricted to thicker glass>0.7 mm. Furthermore, it is essential that the glass is polished for optical or electronic applications after chemical hardening. This procedural step again increases production costs and in the case of thin glass (<0.3 mm) leads to considerable losses due to breakages.

The abovementioned methods are accordingly not to be implemented for thin glass, as used in particular for displays or for data storage or for electronic applications.

With minimal glass thickness, in particular thicknesses <1 mm, or due to the manufacturing process for three-dimensional glass bodies, previously known processes for toughening glass, such as thermal and chemical hardening, are ruled out because these processes are too time-consuming, or produce a surface which must be reprocessed using an expensive polishing procedure and which is not useful for optical, electrical, electronic and optoelectronic applications. In particular in applications where very thin glass (<0.3 mm) is used, it is particularly important to increase the strength of the glass, since this otherwise breaks too easily. Furthermore, thermal hardening is possible only for glass types having a thermal expansion coefficient of >7 ppm/° C. In the abovementioned applications especially glasses having a thermal expansion coefficient of <7 ppm/° C. are used on account of the required thermal geometric stability.

The relatively minimal practical strength of glass as compared to its theoretical strength is caused in particular by damage to and defects in the glass surface. It is accordingly suggested to protect the surface by coating it. DE 36 15 227 A1 thus describes a process in which flat glass is coated with a scratch-proof splinter coating of a synthetic material, such that a synthetic powder is melted onto the still hot surface of the glass. But this method does not produce a surface quality adequate for glass substrates for use in displays or for data media.

U.S. Pat. No. 5,476,692 describes a process for improving the stability of containers made of glass by using an organic resin which is manufactured by polymerisation on the glass. With this process the surface of the glass is certainly well protected and thus becomes more stable against external impact and pressure, but does not describe toughening of the glass by means of compressive or tensile stress being built up in the layer or in the glass.

U.S. Pat. No. 5,455,087 also describes a process for toughening glass containers by polymerisation on the glass surface. Here, too, this increase in strength is achieved only by the protective mechanical effect and not, as described in the process according to the present invention, by means of mechanical prestressing of the polymer layer. Neither is there any mention made of the significance of tear-growth resistance of the polymers in the abovementioned documents.

The object of the invention is to equip a glass body of any type and shape with greater strength. In particular, high surface strength should be achieved with the lowest possible manufacturing expense and low manufacturing costs.

This task is solved by the characteristics of the independent claims.

The invention is therefore based on a glass body which is composed of a base body and a layer applied thereto. At the same time provision is made for the applied layer to be under a defined compressive stress or under a defined tensile stress. The layer has either its own tension, which is already effective when applied to the glass surface, or it obtains this tension from further processing.

When a layer, which is under compressive stress, is applied the tensile stress applied externally must first overcome this compressive stress before the glass breaks. If the applied layer, however, is under tensile stress, a compressive stress is created in the superficial region of the glass. When an external tensile stress is applied this too must first be overcome before the glass breaks.

This defined mechanically prestressed layer may comprise organic, inorganic and organic/inorganic materials. Apart from the mechanical prestressing of the applied layer, with polymer layers the tear-growth resistance of the polymer is important for increasing the mechanical stability of the polymer/glass compound. With the process according to the present invention the selected material, the type and method of coating, or appropriate subsequent treatment accordingly guarantees that a defined mechanical layer stress is produced. Dip coating, centrifuging, laminating, spraying and vacuum treatment, such as sputtering, plasma polymerisation, or plasma-supported chemical precipitation from the vapour phase (PECVD) can be used as possible process for coating.

All materials which can be produced using the process according to the present invention are considered as layer materials. Thermoplasts, duroplasts and elastomers can be used as organic polymers. Polymers such as for example polyvinyl alcohols, polyacrylates, polyarylates, polyesters, polysilicons and the like or also so-called ormocers and materials containing nanoparticles can be applied to the glass by the process according to the present invention, such that defined tensile or compressive stresses are adjusted. This occurs by the selection of the appropriate polymer with respect to molecular weight, degree of hydrolysis, purity, cross-linkable functional groups and by corresponding subsequent treatment can be carried out thermally or photochemically (e.g. UV hardening) or autocatalytically. The layer stress is hereby produced by drying and cross-linking of the polymer. This process also influences the tear-growth resistance (ASIM 0 264) of the polymer. In a preferred embodiment the range of tear-growth resistance is 10 N/mm, and in a particularly preferred embodiment this is in the range of 11-15 N/mm. Values over 10 N/mm mean so-called ‘shear-proof’ elastomers which have a clearly higher initial tearing resistance and tear-growth resistance than standard products.

In order to attain greater strength and high chemical endurance the glass substrate can be coated a number of times. A first layer is applied which is under a defined tensile or compressive stress. To render this mechanically prestressed layer more resistant to chemicals, for instance, a second layer is applied which gives this protection.

Adjusting a specific layer tension is thus made possible with the sputter process by appropriate choice of processing parameters. Materials such as metal oxides (e.g. aluminium oxide), metal nitrides (e.g. aluminium nitride), metal oxinitrides (e.g. AlₓO_{y}N_{z}), metal carbides, metal oxicarbides, metal carbonitrides, semiconductor oxides (e.g. silicon oxide), semiconductor nitrides (e.g. silicon nitride), semiconductor oxinitrides (e.g. SiOₓN_{y}), semiconductor carbides, semiconductor oxicarbides (e.g. SiOₓC_{y}), semiconductor carbonitrides (e.g. SiCₓN_{y}) or metals (e.g. chrome) or mixtures of these materials are considered for this purpose. Plasma polymers can be produced from a plurality of organic and metallorganic volatile compounds. Plasma polymers also can be precipitated according to coating conditions with a defined tensile or compressive stress. With the plasma-supported sputter process and with plasma polymerisation the layer tension is adjusted in particular by a bias stress which lies on the glass to be coated. This bias stress on the substrate can be created by applying a direct voltage, a low-frequency voltage, a medium-frequency voltage or a high-frequency voltage on the substrate.

The vacuum arc process is particularly well suited to creating layers with high mechanical strength from an economical standpoint.

The tensile or compressive stress of the applied layer is of the order of 100-1000 MPa, preferably 200-600 MPa and particularly preferably 300-500 MPa. The glass can be coated single-sided or double-sided. The thickness of the layer is 0.05-50 μm, according to layer material. With plasma polymers and sputtered layers the layer thickness is preferably of the order of 0.05-0.5 μm and particularly preferably 0.1-03 μm. With the polymer layers applied from the liquid phase the layer thickness is of the order of 0.5-50 μm and in a particularly preferred embodiment 1-10 μm.

In a particularly preferred embodiment the coating is applied directly after hot moulding, thus on the glass strip. This can result in an additional increase in the surface stability. This is because the glass is provided with a protective layer immediately after manufacture, effectively preventing scratching or the appearance of corrosion on the surface of the glass.

Due to the mechanical stress in the layer material special significance is given to adhesion of the layer material on the glass. If this adhesion between layer and glass is insufficient, the layer detaches from the glass on account of the layer stress, or develops cracks. For adequate adhesion of the layer on the glass it is effective to improve the adhesion of the layer by way of appropriately pretreating the glass. This can occur by means of corresponding cleaning of the glass surface using aqueous or organic solutions. Other known processes for improving the adhesive strength of glass coatings are corona pretreatment, flaming, plasma pretreatment in a vacuum, UV pretreatment, ozone pretreatment, UV/ozone pretreatment. Special adhesives such as for example silanole, hexamethyldisilazane, aminosilane or polydimethylphenyl siloxane are also used to improve the adhesion of silicon polymers.

The surface strength of the glass can be raised from 580 MPa to 2350 MPa by means of double-sided flat coating of the glass with a layer which is under tensile or compressive stress, which is within the range of intrinsic stability.

If not only the surface of a flat glass substrate, but also the edges of a glass substrate are provided with a layer, which is under mechanical compressive or tensile stress, the surface and edge stability is accordingly increased. This is particularly significant for thin glass substrates of <0.3 mm, because in that case the edges cannot be ground using conventional edge processing methods.

According to the process according to the present invention in particular thin glass with a thickness of less than 0.3 mm, preferably glass with thicknesses of the order of 0.03-0.2 mm, can now be hardened and can also be used for those applications in which otherwise only glass thicker than 0.3 mm is employed. If transparent and heat-resistant materials are used for hardening the glass according to the process according to the present invention, then these glasses can be utilised as substrates for producing displays such as LCDs or PLEDs, for example. In this way stable flexible displays can be manufactured using the process according to the present invention.

In a particularly advantageous embodiment these layers can fulfil other functions still in addition to their stability-reinforcing effect, according to the process according to the present invention. By way of example, they can also act as a diffusion barrier to easily moved alkali ions, or as reflecting layers for reflective displays.

If transparency of the glass substrate is not a requirement, then metallic layers can also be employed to produce layer stresses. Cr layers, and Ta layers in α-modification, which are precipitated at low processing pressures (<4 μbar) and a high separation efficiency, are particularly suitable.

With sputtering of Cr or Ta a tensile stress is established in the metallic layer, which essentially depends on the processing pressure during sputtering. The lower the processing pressure, the higher the tensile stress on account of the higher kinetic energy of the applied layer molecules. In processing pressures >10 μbar the layer stress becomes minimal. Furthermore, the sputter rate decreases sharply due to less ion energy of the Ar^{×} ions.

Another application of the process according to the present invention comprises the manufacture of data media made of glass, in particular so-called hard disks made of glass. To ensure the mechanical stability of these glass hard disks, they generally undergo chemical hardening. This chemical hardening does have some disadvantages, however, such as for example lengthy processing times and surface contamination. Subsequently, glass substrates for hard disks must be polished and washed following chemical hardening. The processes are also highly time-intensive. Because of the process according to the present invention these processes are no longer required and glass hardened by the process according to the present invention can be employed to manufacture hard disks without any further preliminary treatment.

A further application of the process according to the present invention comprises the manufacture of printed circuit boards, which use a thin glass film with a thickness of 30-100 μm, instead of glass fabric. A prestressed layer is effected on the glass by means of coating with an epoxy resin and subsequent cure hardening by means of exposure or heat, thus increasing its surface stability. Next, a copper film is laminated onto the glass treated thus and the electrical circuit carrier is produced by structuring the copper and tipping with additional electrical components. The surface stability is measured using a ring-on-ring method (ROR) with reference to DIN 52292 or draft DIN 52300. The measuring instrument comprises two concentric steel rings, a support ring (radius 20 mm) and a load ring (radius 4 mm). A square sample (50 mm×50 mm) is placed between both load rings and the load on the glass defined by the upper load ring is increased. An anisotropic state of stress is created in the thin glass sample. The tests are performed with a dynamic effect which increases in linear fashion over time, in such a way that a power-controlled stress rate of 2 MPa/s is given. The stress is increased until such time as the glass shatters.

Non-linear power voltage connections are considered for calculating breaking strains. The breaking strains are given as an MPa unit and evaluated in accordance with DIN 55303-7. The values calculated from this estimation method are then given as strength values of the tested glasses.

Various measuring methods are available for determining layer stress in metallic or oxidic thin and thick layers. This measurement is made relatively simply by bending a thin glass strip which is coated using the process according to the present invention. The mechanical layer stress is calculated from the basic mechanical data of the glass, its geometry, measured deformation and layer thickness. The process is described in the following references

E. I. Bromley, J. N. Randall, D. C. Flanders and R. W. Mountain,

“A Technique for the Determination of Stress in Thin Films”

J. Vac. Sci. Technol. B 1 (4), October-December 1983, pp. 1364-1366 and

H. Guckel, 1. Randazzo and D. W. Burns

“A Simple Technique for the Determination of Mechanical Strain in Thin Films with Applications to Polysilicon”, J. Appl. Phy. 57 (5), March 1985, pp. 1671-1675.

### EMBODIMENTS

1. Coating with Polyvinyl Alcohol Directly on the Glass Draw

Alkali-free borosilicate glass of glass type AF 37 by Schott 700 μm thick was coated with polyvinyl alcohol (Mowiol by Clariant; 10% dissolved in H₂O₁) during the glass drawing process (down-draw). The glass temperature was ca. 80° C. when the polyvinyl alcohol (viscosity 1100 mPas) was sprayed on both sides (upper and underside) and dried at 180° C. in a furnace for ca. 15 seconds, during the on-line process. The tensile stress was 0.6 GPa, the layer thickness 10 μm. The surface stability of the same glass without any coating was 512 MPa, while the glass with the abovementioned coating had intrinsic strength, measured with 2.350 MPa.

2. Coating of Glass Substrates with Polyvinyl Alcohol

Alkali-free borosilicate glass (D 263 by Schott Displayglas GmbH) measuring 100×100 mm and 0.4 mm thick was coated with polyvinyl alcohol (Mowiol by Clariant, 16% in H₂O) at room temperature by centrifugal process (2000 min⁻¹, viscosity 250 mPas) and dried at 180° C. for 10 min. The layer thickness was 20 μm. With single-sided coating the surface stability was 706 MPa (with a tensile stress of 0.2 CPa) and with double-sided coating (dipping method) 924 MPa (tensile stress 0.26 GPa). The uncoated samples had a surface stability of 579 MPa.

3. Coating of Glass Substrates with a Silicon Elastomer

Alkali-free borosilicate glass (D 263 by Schott Displayglas GmbH, 100×100 mm) 0.2 mm thick was coated with a polydimethyl siloxane (Elastosil® by Wacker) by dipping (viscosity 70.000 mPas, draw rate 50 cm/min) and dried at 180° C. for 10 min. The layer thickness was 40 μm, the tear-growth resistance of the polymer is 12 N/mm. The tensile strength was 0.14 GPa, while the surface stability was 722 MPa. The uncoated reference had a surface stability of 404 MPa.

4. Coating with a Silicon Resin

Alkali-free borosilicate glass (D 263 by Schott Displayglas GmbH, 100×100 mm) 0.1 mm thick was coated single-sided with an alkyl phenyl silicon resin Silres® (40% solution in xylol) by Wacker by centrifugal process (4000 min⁻¹, viscosity 60 mPas) and dried at 200° C. for 15 min. The layer thickness of the samples was 8.7 μm. The tensile strength was 0.21 GPa and the surface stability 733 MPa, while the uncoated samples exhibited a surface stability of 426 MPa.

5. Coating with a SiCₓO_{y}H_{z} Plasma Polymer

Borosilicate glass (D 263 by Schott Displayglas GmbH, glass thickness 0.4 mm, format 200×200 mm) was coated with hexamethlydisiloxane (HMDSO) as monomer using a low-pressure plasma process. A parallel plate reactor was used for this, such that the lower electrode was connected to a high-frequency generator (1356 MHZ). The applied HF output on the electrode was 300 Watt, while the bias voltage likewise applied to this electrode was −300 V. After 30 minutes the layer thickness was 0.6 μm. A SiCₓO_{y} layer was created which had a compressive stress of 0.3 GPa. The surface stability of the coated samples was 1420 MPa, while the uncoated samples had a surface stability of 579 MPa.

6. Coating with a SiCₓN_{y}H_{z} Plasma Polymer

Using high-frequency low-pressure plasma in a parallel plate reactor borosilicate glass (D 263 by Schott Displayglas GmbH, format 150×150 mm, 400 μm thick) was used to produce a 0.42 μm thin SiCₓN_{y}H_{z} layer of tetramethylsilane (TMS) and nitrogen. Precipitation lasted for 20 minutes. The pressure was 0.11 mbar. A flow of 5 sccm (Standard cubic centimetre per minute) TMS and 24 sccm nitrogen was set. The processing pressure was 0.2 mbar. The compressive stress of the plasma polymer layer was 0.6 GPa. The surface stability was 1120 MPa, while the uncoated samples had a surface stability of 579 MPa.

7. D 263 Glass/Silicon Resin/Silicon Elastomer Compound

A glass film measuring 100×100 mm of glass type ID 263 (trade literature of Schott-Desag) is used as a glass substrate with a thickness of 100 μm, manufactured by the down-draw process. The strength of this glass substrate is ca. 470 MPa. The glass substrate is coated using a centrifugal process (5000 1/min) with a methylphenyl silicon resin (brand name Silres® by Wacker-Chemie GmbH, silicon resin/xylol solution mass ratio 1:3) and then dried at 220° C. for 15 min in a circulating air oven. The layer thickness is 4.5 μm, the tensile strength 0.21 CPa and the surface stability ca. 980 MPa. Because silicon resins display minimal chemical resistance relative to ketones inter alia, a second layer is applied. The silicon resin-coated glass substrates are coated with a silicon polymer film based on polydimethyl siloxane (brand name Elastosil® by Wacker-Chemie GmbH, viscosity 70000 mPas) using a centrifugal process (5000 1/mm) and dried at 200° C. for 20 min in a circulating air oven. The layer thickness is 45 μm. With the first coating the strength clearly increased, and the chemical resistance in particular relative to ketones was improved by the second coating.

8. Coating with an Amorphous Silicon Nitride Layer by means of Plasma Enhanced Chemical Vapour Deposition (PECVD)

| | |
|---|---|
| Substrate: | AF45 0.7 mm × 400 × 400 mm by |
| | Schott Displayglas |
| Plant: | PI/PE-CVC reactor horizontal configur- |
| | ation with plasma cage |
| Plasma excitation frequency: | 13.56 MHz |
| Plasma output: | 40 W |
| Temperature: | T ≈ 300° C. |
| Precursor gases: | SiH₄ 65 sccm, NH₃, 280 sccm |
| Carrier gases: | N₂ 800 sccm, H₂ I78 sccm |
| Processing pressure: | 890 μbar |
| Layer thickness: | ˜450 nm |
| Layer stress: | σ₀ ≈ −345 . . . −380 MPa |
| Surface stability without coating: | σ₀ ≈ 540 MPa |
| Surface stability with coating: | σ_{0S} ≈ MPa |

9. Coating with a Silicon Oxide Layer (SiOₓ) by Powdering (Sputtering, PVD, Phys. Vapor Deposition)

| | |
|---|---|
| Substrate: | D263 0.4 × 400 × 400 mm³ by Schott |
| | Displayglas |
| Plant: | Vertical inline sputter plant with water- |
| | cooled magnetron cathode and HF |
| | plasma generation |
| Source: | 2 × linear water-cooled magnetron |
| | cathode 488 mm wide with intermediate |
| | cool zone |
| | Fully oxidised quartz glass target |
| Plasma excitation frequency: | 13.56 MHz |
| Plasma output: | 2500 W |
| Substrate temperature: | 250° C. |
| Carrier gases: | Ar 40 sccm, Kr 5 sccm, O₂ x sccm |
| Running speed: | 0.1 m/min |
| Processing pressure: | 2.9 μbar |
| Layer thickness: | ˜2850 nm |
| Layer stress: | σ_{S} ≈ −180 . . . −250 MPa |
| Surface stability without coating: | σ₀ ≈ 579 MPa |
| Surface stability with coating: | σ_{0S} ≈ 722 MPa |

10. Coating of Glass Substrates with Aluminium Oxide (AlOₓ) by Powdering (Sputtering, AVD Phys. Vapor Deposition)

| | |
|---|---|
| Substrate: | D 263 0.4 × 400 × 400 mm³ |
| Plant: | Vertical inline sputter plant with water- |
| | cooled magnetron cathode and HF |
| | plasma generation |
| Source: | 2 × linear water-cooled magnetron |
| | cathode 488 mm wide |
| Plasma excitation frequency: | 13.56 MHz |
| Plasma output: | 2 × 2500 W |
| Carrier gases: | Ar 50 sccm, Kr 5 sccm, O₂ 5 sccm |
| Substrate temperature: | 250° C. |
| Running speed: | 0.15 m/min |
| Processing pressure: | 3.2 μbar |
| Layer thickness: | ˜280 nm |
| Layer stress: | σ_{S} ≈ −250 . . . −330 MPa |
| Surface stability without coating: | σ₀ ≈ 579 MPa |
| Surface stability with coating: | σ_{0S} ≈ 754 Mpa |

11. Application of Cr by Sputtering in the Magnetron Field

| | |
|---|---|
| Substrate: | AF 45 0.7 with thickness of 400 mm |
| | glass strip width by Schott Displayglas |
| Plant: | Vertical inline sputter plant with water- |
| | cooled magnetron cathode and DC |
| | plasma generation |
| Source: | Linear magnetron cathode 488 mm wide |
| | Cr target |
| Plasma excitation frequency: | 13.56 MHz |
| Plasma output: | 4 kW |
| Carrier gases: | Ar 40 sccm |
| Processing pressure: | 2.6 μbar, pressure increase at plasma |
| | ignition to ˜15 μbar |
| Layer thickness: | ˜400 nm |
| Layer stress: | σ_{S} ≈ −350 . . . −400 MPa |
| Surface stability without coating: | σ₀ ≈ 515 MPa |
| Surface stability with coating: | σ_{0S} ≈ 1520 MPa |

12. Coating of Glass Substrates with Aluminium Oxide (A1₂O₃) by Vapour Deposition in e-Beam Process

| | |
|---|---|
| Substrate: | D 263 0.4 × 50 × 50 mm |
| Plant: | Vacuum vaporisation plant with planet |
| | suspension |
| Source: | Balzers e-Beam on Al₂O₃, source |
| | distance 450 mm |
| Residual gas pressure: | 10⁻⁵ mbar |
| Layer thickness: | ˜300 nm |
| Layer stress: | σ_{S} ≈ 225 255 MPa (compressive stress) |
| Surface stability without coating: | σ₀ ≈ 404 MPa |
| Surface stability with coating: | σ_{0S} ≈ 631 MPa |

13. Coating of Glass Substrates with Silicon Resins

Borosilicate glass containing alkali (D 263 T by Schott Displayglas GmbH, format 100×100 mm) 0.1 mm thick was dissolved with a polysiloxane Silres® containing methyl groups by Wacker in xylol (55% solution) and filtered. Next, a 5% solution of F 100 (Wacker) in xylol is added for faster cross-linking of the polysiloxane solution and stirred with a magnetic agitator. The glasses are coated with the polymer solution using a centrifugal process (1000 min⁻¹) and dried at 230° C. for 60 min in a circulating air oven. The layer thickness of the sample was 5.3 μm. The tensile strength was 0.19 GPa and the surface stability 814 MPa, while the uncoated samples had a surface stability of 426 MPa.

14. Coating of Glass Substrates with Acrylate Epoxy Polymer Mixture

Borosilicate glass containing alkali (D 263 by Schott Displayglas GmbH, format 100×100 mm) 0.1 mm thick was coated double-sided with a polymer mixture of polyacrylate and polyepoxy by Clariant (centrifugal process 800 min′) and dried at 230° C. for 30 min in a circulating air oven. The layer thickness of the sample was 3.5 μm, the tensile strength 0.18 CPa and the surface stability 790 MPa, while the uncoated samples had a surface stability of 426 MPa.

15. Coating with Polyurethane Resin

15.1 2 K System

Borosilicate glass containing alkali (D 263 by Schott Displayglas GmbH, format 100×100 mm) 0.2 mm thick was coated with a polyurethane lacquer (Desmodur/Desmophen, Bayer) in a spin-coat process. The viscosity of the resin system was adjusted with a non-polar solvent such that at 2000 rpm a layer thickness of 5 μm resulted. The system was cure hardened for 10 min at 120° C. The tensile strength was 0.17 GPa and the surface stability 683 MPa, while the uncoated samples had a surface stability of 404 MPa.

15.2 1 K System

Borosilicate glass containing alkali (D 263 by Schott Displayglas GmbH, format 300×400 mm) 0.2 mm thick was coated with 1 K PU lacquer Coetrans (Coelan) by a spraying process. The lacquer was diluted with MIBK to a solids content of 20%. The lacquer was applied using an air atomiser nozzle (air pressure 2 bar), with the layer thickness 20 μm. The coating cure hardens at room temperature within 1 hour by reacting with humidity. The samples had a tensile strength of 0.15 CPa and a surface stability of 679 MPa, while the uncoated samples had a surface stability of 404 MPa.

15.3 Coating with Aqueous PU System

Borosilicate glass containing alkali (D 263 by Schott Displayglas GmbH, format 300×400 mm) 0.2 mm thick was coated with the aqueous lacquer system Hydroglasur (Diegel) by a spraying process. The spray pressure was 3 bar, the nozzle diameter 0.8 mm. According to requirements layers thicknesses between 5 and 15 μm were obtained, such that the tensile strength was 0.18 GPa and the surface stability was 752 MPa, while the uncoated samples had a surface stability of 404 MPa.

16. Coating with Epoxy Resin

Borosilicate glass containing alkali (D 263 by Schott Displayglas GmbH, format 100×100 mm) 0.2 mm thick was coated with 2 K epoxy Stycast 1269 A (Grace) in a spin-coat process (1500 s⁻¹) and hardened for 3 h at 120°. The layer thickness was 7.2 μm, the tensile strength 0.18 GPa and the surface stability 748 MPa (surface stability of the uncoated reference 404 MPa).

17. Coating with Silicon Elastomer (Platinum-catalysed Addition-cross-linked)

Borosilicate glass containing alkali (D 263 by Schott Displayglas GmbH, format 100×100 mm) 0.2 mm thick was coated with an addition-cross-linking silicon in a spin-coat process (1300 s⁻¹). The coating solution had the following ingredients:

10.0 g vinyl siloxane

0.4 g cross-linker

0.1 g platinum catalyst

5.0 g ethyl acetate

After centrifuging the coating was hardened under an IR ray field in 5 sec and a layer thickness of 97 μm was obtained. The tensile strength of the coated samples was 0.19 GPa and the surface stability 783 MPa, while the uncoated samples had a surface stability of 404 MPa.

18. Coating with UV-hardening Systems

Alkali-free borosilicate glass (D 263 by Schott Displayglas GmbH, 100×100 mm) thickness 0.2 mm was coated with UV-hardening lacquer systems in a spin-coat process (1300 s⁻¹). The lacquer systems were based on both acrylates and epoxies. These lacquer systems are hardened using a fusion lamp (lamp type H) and an output of 180 W/cm², which was guided at a rate of 6 m/min over the coated samples. The thickness of the acrylate coating was 7.6 μm (tensile stress 0.2 GPa, surface stability 658 MPa). The surface stability of the uncoated reference had 404 MPa.

1. A toughened glass body:
1.1 comprising a base body of glass and at least one layer applied thereto;
1.2 at least one layer is under compressive stress or tensile stress.

2. A glass body as claimed in claim 1, characterised in that the compressive or tensile stress is of the order of 100 to 1000 MPa.

3. A glass body as claimed in claim 1 or 2, characterised in that the layer material comprises organic or inorganic materials or a mixture or a compound of organic and inorganic materials.

4. A glass body as claimed in any one of claims 1 to 3, characterised in that the layer under stress covers the surface of the glass body entirely or partially.

5. A glass body as claimed in any one of claims 1 to 4, characterised in that the base body is present as flat glass, bent flat glass or as container glass.

6. A glass body as claimed in claim 5, characterised in that the thickness of the base body is of the order of 10 to 1500 μm.

7. A glass body as claimed in any one of claims 1 to 6, characterised in that the base body is flexible and the thickness of the glass is of the order of 10 to 200 μm.

8. A glass body as claimed in any one of claims 1 to 7, characterised in that at least one of the two or more layers is applied for protecting the layer or layers under stress.

9. A process for manufacturing a glass body as claimed in any one of claims 1 to 8, characterised by the following procedural steps:
9.1 one or more layers is or are applied to the glass by dipping, centrifuging, laminating or spraying of organic polymers, inorganic materials or organically modified ceramic materials by means of sol gel technology;
9.2 at least one layer is reprocessed to adjust the required layer stress.

10. A process as claimed in claim 9 characterised in that the layer comprises a polymer whose tear-growth resistance is at least 10 N/mm.

11. A process as claimed in claim 9, characterised in that there is subsequent processing by means of thermal drying, electromagnetic radiation, UV treatment, UV/ozone treatment, corona treatment, electron radiation and flaming.

12. A process as claimed in any one of claims 1 to 8, characterised in that coating is carried out in a vacuum using physical vaporising or sputter processes.

13. A process as claimed in any one of claims 1 to 8, characterised in that coating is carried out by means of plasma-supported precipitation from the gaseous phase, by plasma polymerisation or by a plasma arc process.

14. A process as claimed in claim 11, characterised in that metals, semiconductors, metal oxides, semiconductor oxides, metal nitrides, metal carbonitrides, metal oxynitrides, metal oxycarbides, semiconductor nitrides, semiconductor carbonitrides, semiconductor oxynitrides, semiconductor carbides, or metals or mixtures of these materials.

15. A process as claimed in claim 12, characterised in that volatile metal compounds or volatile organic or metallorganic compounds are used as starting materials.

16. A process as claimed in any one of claims 11 to 14, characterised in that the layer stress is set by a bias, generated by applying a direct voltage or an alternating voltage to the substrate.

17. A process as claimed in any one of claims 1 to 15, characterised in that coating and subsequent treatment are carried out immediately after hot moulding.

18. Displays manufactured with glass substrates as claimed in claims 1 to 16.

19. Hard disks manufactured with glass substrates as claimed in claims 1 to 16.

20. Electrical circuit carrier manufactured with glass substrates as claimed in claims 1 to 16.

21. Hardened flat glass as claimed in claims 1 to 8, characterised in that coating on at least one side fulfils further functional characteristics.

22. Hardened flat glass as claimed in claim 17, characterised in that the coating on at least one side serves as blooming coat.

23. Hardened flat glass as claimed in claim 17, characterised in that the coating on at least one side serves as reflecting or absorption layer.

24. Hardened flat glass as claimed in claim 17, characterised in that the coating on at least one side serves as diffusion barrier.

25. Hardened flat glass as claimed in claim 17, characterised in that the coating on at least one side serves as photo-sensitive layer.

26. Hardened flat glass as claimed in claim 17, characterised in that the coating on at least one side serves as polariser.

27. Hardened flat glass as claimed in claim 17, characterised in that the coating on at least one side serves as information storage.
